(19) United States
(12) Patent Application Publication
(10) Pub. No.: US 2013/0168318 A1
(43) Pub. Date: Jul. 4, 2013

(54) Method for Treating Water by Ballasted Flocculation Implementing a Natural Flocculent

(71) Applicants: Celine Levecq, Paris (FR); Philippe Sauvignet, Saint-Etienne-En-Cogles (FR)

(72) Inventors: Celine Levecq, Paris (FR); Philippe Sauvignet, Saint-Etienne-En-Cogles (FR)

(73) Assignee: VEOLIA WATER SOLUTIONS & TECHNOLOGIES SUPPORT, Saint-Maurice Cedex (FR)

(21) Appl. No.: 13/641,745

(22) PCT Filed: Apr. 18, 2011
(86) PCT No.: PCT/EP2011/056164

§ 371 Date: Mar. 18, 2013

(30) Foreign Application Priority Data
Apr. 20, 2010 (FR) 1053012

(51) Int. Cl. C02F 1/52

(52) U.S. Cl. CPC C02F 1/5263
USPC 210/666; 210/728; 210/727

(57) ABSTRACT

Method for treating water by ballasted flocculation comprising a step for injecting into said water at least a flocculent, a step for injecting into said water at least one particulate material that is denser than water, and a step for retrieving treated water, characterised in that said ballasted flocculation is performed under agitating at a mean speed gradient between 100 and 1400 s⁻¹ and in that said flocculent consists of at least one natural carbohydrate polymer having an anionic charge density between −900 and −4000 μeq/g.

### 1. FIELD OF THE INVENTION

The field of the invention is that of the treatment of all types of water in order to clean it and make it drinkable.

More specifically, the invention pertains to a technique of water treatment including a step of ballasted flocculation.

### 2. PRIOR ART

Methods of this type consist in the addition, to the water to be treated, of one or more reagents enabling the flocculation, i.e. the combining in the form of flocs, of at least a major part of the pollutant matter present in water, and then the separating of these flocs of pollutant matter from purified water.

Flocculation is generally preceded by coagulation.

The coagulation consists of the injection of at least one coagulant reagent into the water to be treated in order to reduce or remove the electrical charges carried by the pollutant matter present in the water in the form of suspended colloidal particles, in order to promote its subsequent agglomeration in the form of flocs.

Flocculation consists of the injection of at least one flocculent reagent into preferably pre-coagulated water so as to form large, easily separable particles or flocs by the agglomeration of the colloidal particles suspended in water. The flocculation is facilitated by the preliminary implementation of coagulation.

Purified water is then obtained by separating the flocs suspended therein by settling.

In one variant, a granular material denser than water, such as sand, preferably having a grain size of 60 to 300 micrometers, can be injected into the water to be treated upstream or during flocculation so as to ballast the floc and thus promote and accelerate its decantation. A technique of this kind is described especially in the French patent document published under FR2627704.

A flocculation step, during which or upstream to which, a granular material denser than water or a ballast is injected into the water is commonly called ballasted flocculation.

In order to maintain the ballast in suspension in the water to be treated and thus foster the formation of flocs about the grains of ballast, the ballasted flocculation is implemented under agitating. The flocculation step thus takes place inside a flocculation tank more usually housing a mechanical stirrer of the blade stirrer type.

Thus, in order that the ballasted flocculation may be efficient, it is desirable that the specific speed should be greater than 0.1 m·s⁻¹ in the tank within which the ballasted flocculation is implemented.

The specific speed is equal to the ratio between the pump flow rate Qₚ at which the treated water is agitated in the flocculation tank and the floor area of this tank.

Furthermore, it is known that the power P of the stirrer can be computed according to the following formula (Nₚ characterizes the drag coefficient of the stirrer in the fluid):

P=ρNₚN³D⁵

and that the intensity of the mixing in the tank can be evaluated by the mean speed gradient G;

$$G = \sqrt{\frac{P}{V μ}}$$

The mean speed gradient G can thus be computed according to the following formula:

$$G = \sqrt{\frac{ρ {N}_{p} {N}^{3} {D}^{5}}{V μ}}$$

where:
Qp is the pump flow rate (m³·s⁻¹)
Np is the power number
N is the speed of rotation of the stirrer (rpm⁻¹)
D is the diameter of the stirrer (m)
ρ is the density of the fluid (kg·m⁻³)
μ is the kinematic viscosity of the fluid (kg·s·m⁻¹)
V is the volume of the tank (m³)
P is the power of the stirrer (kg·m²·s⁻³)
G is the mean speed gradient (s⁻¹)

The implementation of a stirrer of this kind therefore makes it possible to cause a mean speed gradient G, generally ranging from 100 and 1400 s⁻¹, to prevail within the flocculation tank.

The mean speed gradient prevailing within the flocculation tank generates shear forces on the flocs that are in suspension therein.

The flocs must therefore have high mechanical resistance so as not to separate under the effects of these shear forces. To this end, the flocculent reagents, also called flocculation additives, which are used must give the flocs sufficient mechanical resistance.

The flocculent agents currently implemented to meet these constraints are organic. They are most often synthetically obtained petroleum derivatives.

The implementation of this type of flocculent is advantageous in that it contributes to creating flocs resistant to the hydraulic conditions inherent in ballasted flocculation and therefore enables the efficient production of water treated by ballasted flocculation. This implementation however has some drawbacks.

### 3. DRAWBACKS OF THE PRIOR ART

In particular, some organic flocculent reagents, such as for example polyacrylamide, are currently suspected of being carcinogenic products. Consequently, it could be that their implementation is not wholly neutral as regards the health of the operators who handle them or consumers who use the treated water produced by methods implementing such organic flocculants.

Furthermore, these organic flocculants found in the settling sludges obtained after the separation of the flocs are not biodegradable. These sludges are generally collected in order to be incinerated or used as fertilizer. The organic flocculants that they contain can then be a source of atmospheric or soil pollution.

Thus, legal restrictions on the use of such organic flocculants should ultimately lead to the prohibition of their use in water treatment.

Furthermore, in water treatment methods implementing filtration of treated water produced by ballasted flocculation, the organic flocculants are a source of clogging of the filtration membranes implemented to this end.

Furthermore, since the current organic flocculants are petroleum byproducts, the development of their cost is closely linked to petroleum prices which are on the whole rising and should continue to rise given the fact that petroleum is scarce. Their implementation thus has a considerable impact on the total cost of the treatment of water.

### 4. GOALS OF THE INVENTION

The invention is aimed especially at overcoming these drawbacks of the prior art.

More specifically, it is a goal of the invention to provide a technique of water treatment by ballasted flocculation, the implementation of which has limited or even zero ecological impact.

In particular, the invention is aimed at providing a technique of this kind that has no effect on the health of the operators who implement it or consumers who use the treated water produced by a technique of this kind.

It is another goal of the invention to implement a technique of this kind which has a level of efficiency equivalent to, if not close to, that of current techniques for treating water by ballasted flocculation.

It is yet another goal of the invention to provide a technique of this kind for which the implementation is at the very least not more costly than current techniques of water treatment by ballasted flocculation.

In particular, the invention is aimed at providing a technique of this kind that limits the clogging of the membranes likely to be implemented in order to filter treated water produced by ballasted flocculation.

### 5. SUMMARY OF THE INVENTION

These goals, as well as others that shall appear here below, are attained by a method for treating water by ballasted flocculation comprising a step for injecting into said water at least a flocculent, a step for injecting into said water at least one particulate material denser than water, and a step for retrieving treated water, said ballasted flocculation being performed under agitation at a mean speed gradient between 100 and 1400 s⁻¹ and in that said flocculent consists of at least one natural carbohydrate polymer having an anionic charge density between −900 to −4000 μeq/g.

In the present description, the term “natural carbohydrate polymer having an anionic charge density” is understood to mean:
any carbohydrate polymer extracted from plant material especially starch, functionalized by transplant of anionic reactive groups according to classic techniques known to chemists specialized in this field,
   as well as:
any natural carbohydrate polymer extracted from plant material and naturally presenting groups that are naturally anionic or can be made anionic.

The general principle of the invention therefore relies on the implementing of carbohydrate polymers of natural origin functionalized as flocculants in a treatment of water by ballasted flocculation conducted in conditions of high mean speed gradient, said polymer having a charge chosen from a particular range.

Such an implementation was in no way obvious in the prior art since high mean speed gradients result from heavy shear stresses in the flocs. Indeed, it had already been proposed in the prior art to use natural carbohydrate polymers, namely starch, in non-ballasted flocculation methods but these techniques had been forsaken because the flocs formed had poor cohesion, disintegrated too easily in practice and did not properly fulfill their role. Now, the techniques of non-ballasted flocculation use mean speed gradients that are far smaller than those implemented in ballasted flocculation techniques. Those skilled in the art of water treatment were therefore in no way encouraged to envisage the use of such polymers in these ballasted flocculation techniques, given this state of the prior art.

Besides, the Applicant, after much research, has demonstrated that only certain natural carbohydrate polymers could efficiently cope with these constraints of high mean speed gradients capable of carrying out ballasted flocculation and that, in order to achieve this purpose, these polymers had to have an anionic charge density selected from the range indicated above.

The invention enables the production of treated water of a quality equivalent to water treated by ballasted flocculation implementing a classic synthetic organic flocculent polymer while at the same time being more environment-friendly and having a limited impact on the health of individuals: this is because the anionic flocculants based on functionalized natural carbohydrate polymer according to the invention are biodegradable.

Said flocculent is preferably based on substituted starch. Substituted starches are preferred because they are less costly and more easily available in the market. The range of anionicity from −900 μeq/g to −4000 μeq/g of a substituted starch corresponds to a substitution rate ranging from 0.1 to 0.5 approximately.

Also advantageously, the substituent or substituents of said substituted starch is/are selected from the group comprising carboxylate, sulphonate, phosphate, phosphonate substituents.

According to a first preferred embodiment, a method according to the invention comprises a coagulation step upstream to said ballasted flocculation step.

Also preferably, said ballasted flocculation step is followed by a settling step.

According to a second preferred embodiment, a method according to the invention comprises a step for injecting activated carbon into said water upstream to said coagulation step.

In this case, a method according to the invention preferably comprises a filtration step, especially by membranes, after said settling step.

The performance of a filtration downstream from the settling step enables the treated water to be separated into carbon fines and an excess of flocculent.

Preferably, a method according to the invention comprises in this case an additional coagulation step performed immediately before said filtration step.

The additional coagulation gives rise to the formation of flocs with the excess polymer contained in the water derived from the settling. These flocs have a greater size than that of the particles initially present in the water coming from the settling step. These flocs are deposited on the surface of the membranes of the filtration unit while the particles initially present in the water coming from the flocculation penetrate therein to a greater depth. The performance of the second coagulation is therefore advantageous because it limits the clogging of the filtration unit or at any rate makes it easier to unclog.

The inventors have furthermore discovered that, surprisingly for natural polymers, the ion load of these polymers should preferably be chosen as a function of the alkalinity of the water. In practice, the harder the water to be treated, the closer to −4000 μeq/g will the density of the anionic charge be. The less hard the water, the closer to −900 μeq/g will the density of the anionic charge be.

Thus, the method of the invention comprises a preliminary step for selecting said flocculent according to the hardness of the water to be treated, the harder the water, the more anionic the flocculent.

Again according to a preferred variant of the invention, said step for injecting at least one flocculent into said water is performed by adding said flocculent to the previously coagulated water in an amount ranging from 0.1 to 5 ppm, preferentially between 0.1 and 2 ppm as a function of the charge of the water to be treated in pollutant matter capable of flocculating.

These content values are far greater than those implemented with synthetic polymers. Those skilled in the art could therefore have feared that the implementation of such high content values would have prompted a sharp increase in the biological DOC (biodegradable dissolved organic carbon “bDOC”). The bDOC is estimated from the decrease in dissolved organic carbon DOC after a lengthy incubation period (28 days) in the presence of a suspension of bacteria (AFNOR T 90-318) or a fixed biomass (AFNOR T 90-319). Surprisingly however, there is no such increase whatsoever.

Finally, according to one variant of the invention, said ballasted flocculation is implemented under agitating with a mean speed gradient between 200 to 800 s⁻¹. This range of gradient is the one implemented in the majority of flocculation reactors.

### 6. LIST OF FIGURES

Other features and advantages of the invention shall appear more clearly from the following description of preferred embodiments given by way of simple, illustrative and non-exhaustive examples and from the appended drawings, of which:

FIG. 1 illustrates an installation for implementing a first embodiment of a method according to the invention;

FIG. 2 illustrates an installation for implementing a second embodiment of a method according to the invention;

FIGS. 3 and 4 are graphs expressing comparisons of performance of the treatment of water charged with organic material in an installation of the type shown in FIG. 1, implementing firstly a prior-art synthetic organic flocculent and, secondly, implementing a natural flocculent according to the present invention;

FIG. 5 is a graph illustrating the fact that the flocculent used according to the present invention is less clogging than classic flocculation additives.

### 7. DESCRIPTION OF EMBODIMENTS OF THE INVENTION

### 7.1. Reminder of the General Principle of the Invention

The general principle of the invention relies on the implementation of an anionic flocculent consisting of a natural carbohydrate polymer for treating water by ballasted flocculation conducted with a high mean speed gradient.

Such an implementation enables the production of treated water having a quality equivalent to that of water treated by ballasted flocculation implementing a synthetic organic flocculent polymer while at the same time being more environment-friendly and person-friendly because flocculents consisting of natural carbohydrate polymers are biodegradable.

Furthermore, this type of flocculent has the advantage, as compared with synthetic organic flocculents, of enabling the production of treated water whose clogging potential is lower. This water can then be filtered while, at the same time, the constraints on the unclogging of the filtering units used for this purpose are limited.

### 7.2. Example of a First Embodiment

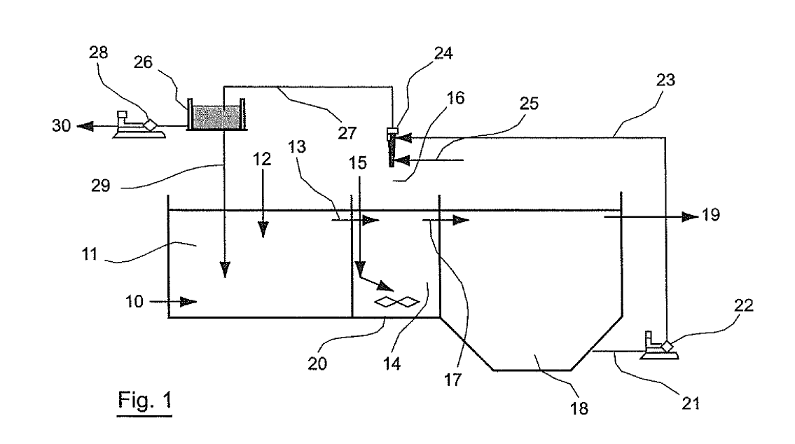

Referring now to FIG. 1, we present a first embodiment of a method for treating water by ballasted flocculation according to the invention.

Such a method consists in introducing water to be treated 10, which is for example preliminarily clarified or floated, into a coagulation tank 11 into which there is injected a coagulant 12 which, in this embodiment, consists of ferric chloride (FeCl₃), a commercially available product.

The water thus coagulated 13 is introduced into an agitated ballasted flocculation tank 14 into which are injected a flocculent 15 and a particulate material denser than water 16, or ballast, which in this embodiment is microsand. The flocculation tank 14 houses a blade stirrer 20 which is implemented in such a way that, within this tank, there prevails a mean speed gradient of 300 to 1400 s⁻¹.

The flocculent 15 consists of a natural carbohydrate polymer, preferably substituted starch, and has an anionic charge density preferably ranging from −900 to −4000 μeq/g. When it is substituted starch, a range of anionic charge density such as this corresponds to a substitution rate of 0.1 to 0.5. The substituents are then advantageously chosen from the group comprising carboxylates, sulfonates, phosphates and phosphonates substituents.

The coagulated and flocculated water 17 is introduced into a settling tank 18 at the bottom of there get deposited sludges constituted by ballasted flocs separated from a clarified water extracted as an overflow 19.

The sludges 21 are extracted from the decanter 18 for example by means of a recirculation pump 22 and are introduced through a piping 23 into a hydrocyclone 24 into which the service water 25 is injected.

A sludge/microsand mixture highly charged with microsand 16 is poured out in an underflow from the hydrocyclone 24 into the ballasted flocculation tank 14.

A sludge/microsand mixture highly charged with sludge 27 is poured out as an overflow from the hydrocyclone 24 into an outflow chute 26.

A partly dehydrated mixture 30 is extracted from the chute 26 by means of an extraction pump 28 and the effluent 29 coming from this dehydration is injected into the coagulation tank 11.

In one variant of this embodiment, it may be planned not to perform any coagulation.

### 7.3. Example of a Second Embodiment

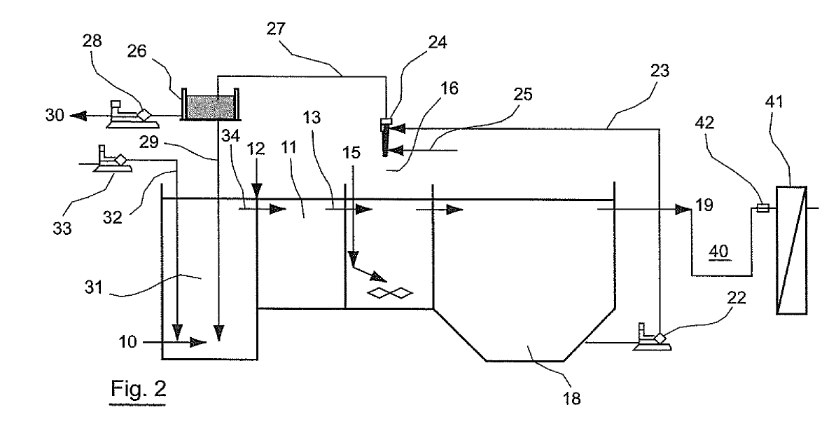

Referring to FIG. 2, we present a second embodiment of a method of treating water by ballasted flocculation according to the invention.

This second embodiment is distinguished from the previous one especially by the fact that:
the water to be treated 10 is introduced into a stirred pre-contact tank 31 into which powdered activated carbon 32 (PAC) is injected through a pump 33, and that
the effluent 27 coming from the outflow chute 26 is injected into this pre-contact tank 31.

The mixture of water to be treated and PAC 34 is then introduced into the coagulation tank 11.

This second embodiment is further distinguished from the first one by the fact that the treated water produced 19 is introduced into a coagulation chamber 40 into which a coagulant is introduced, and then into a filtration unit consisting of a pre-filter 42 having a 150-micrometer cut-off point and a membrane ultrafiltration module 41 having a 25-nm cut-off point.

The performance of a filtration downstream from the settling step enables the separation of the treated water from the coal fines and an excess of flocculent.

The coagulant implemented in the coagulation zone immediately preceding the filtration unit gives rise to the formation of flocs with the excess flocculent contained in the water that exits from the settling tank. These flocs have a size greater than that of the particles initially present in the water coming from the settling step. These flocs are deposited on the surface of the membranes of the ultrafiltration unit while the particles initially present in the water coming from the settling step penetrate the ultrafiltration unit to a greater depth. The implementation of this coagulation is therefore advantageous because it makes it easier to unclog the ultrafiltration unit.

A method according to this second embodiment comprises phases of cleaning the ultrafiltration unit. These cleaning phases (preventive maintenance) are of two types: hydraulic cleaning operations which consist of backwashing and chemical cleaning operations which implement chemical cleaning approaches.

### 7.4. Comparative Trials

7.4.1. Trials in the Implementation of a Method According to the First Embodiment

Trials were made to compare the efficiency of a ballasted flocculation implementing either, according to the invention, a natural flocculent based on starch and/or modified alginate or, according to the prior art, a synthetic organic flocculent.

A first test consisted in treating raw water having a DOC (dissolved organic carbon) content equal to 10.6 mg/l and an alkalinity of 5° f (i.e. 50 mg/l of CaCO₃) by the implementation of a method of ballasted coagulation-flocculation according to the first embodiment described here above with the following characteristics:
feeding the coagulation tank with water to be treated at a flow rate of 50 m³/h;
mean speed gradient in the flocculation tank equal to 800 s⁻¹;
injecting a dose of 150 ppm of ferric chloride FeCl₃ (commercially available product) as a coagulant;
injecting a dose of 0.2 ppm of anionic polyacrylamide with an anionic charge density of −1400 μeq/g commercially distributed under the name FLOPAM AN905 for the firm SNF FLOERGER as a synthetic organic flocculent.

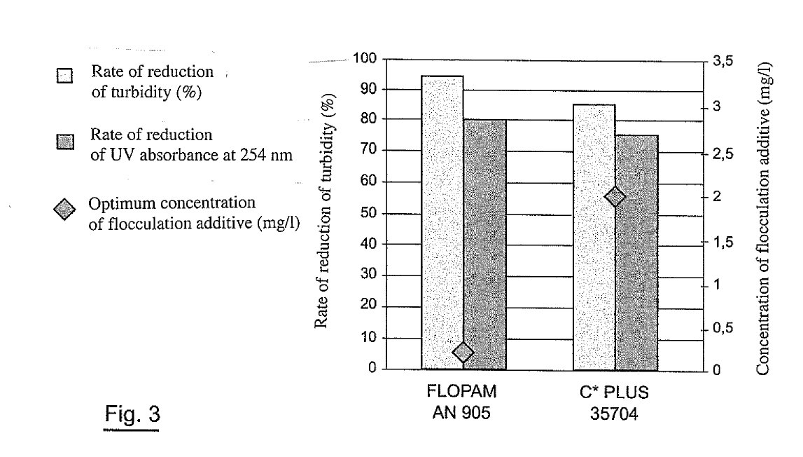

As shown in FIG. 3, referring to the first two columns of this figure, the implementation of such a treatment enabled an:
approximately 93% reduction in the turbidity of the raw water;
approximately 80% reduction in the UV absorbance at 254 nm.

This treatment enabled the production of treated water for which the DOC content is equal to 3.3 mg/l.

A second test consists in treating raw water having a DOC content equal to 10.8 mg/l by the implementation of a ballasted coagulation-flocculation method according to the first embodiment with the following characteristics:
feeding the coagulation tank with water to be treated at a flow rate equal to 50 m³/h;
mean speed gradient in the flocculation tank equal to 800 s⁻¹;
a dose of 150 ppm of ferric chloride FeCl₃ (a commercially available product) as a coagulant;
a dose of 2 ppm of substituted starch commercially distributed under the trade name C* plus 35704 by the firm Cargill with an anionic charge density equal to −900 μeq/g as a flocculent.

The anionic charge of this starch was measured by means of an apparatus, namely the MÜTEK PCD-04 Travel pack (zetameter), commercially distributed in France by Noviprofibre under reference X20128.

As shown in FIG. 3, referring to the two second columns of this figure, the implementation of such a treatment made it possible to:
reduce the turbidity of the raw water by about 87%;
reduce the UV absorbance at 254 nm by about 76%.

This treatment leads to the production of treated water for which the DOC content is equal to 3.6 mg/l.

The following table 1 indicates, for these two tests, the polymer dose used, the coagulant dose used, the biodegradable DOC of the raw water and the treated water and the DOC of the raw water and the treated water.

TABLE 1

| | | | | | Coagulant |
|---|---|---|---|---|---|
| | Bio- | | | polymer | dose |
| | degradable | DOC* | polymer | dose | (FeCl3) |
| Sampling point | DOC (mg/l) | (mg/l) | used | (ppm) | (ppm) |
| Raw water | 1.8 | 10.8 | C*PLUS | 2 | 150 |
| Water outflow | 1.2 | 3.6 | 35704 | | |
| after | | | | | |
| ballasted | | | | | |
| coagulation- | | | | | |
| flocculation | | | | | |
| and settling | | | | | |
| Raw water | 2.8 | 10.6 | FLOPAM | 0.2 | 150 |
| Water outflow | 0.8 | 3.3 | AN905 | | |
| after | | | | | |
| ballasted | | | | | |
| coagulation- | | | | | |
| flocculation | | | | | |
| and settling | | | | | |

COD*: the precision of the measurement is 0.3 mg/l

The results of these two tests show that the use of a natural flocculent polymer according to the invention enables the production of a treated water with a quality as satisfactory as that obtained by using a classic synthetic organic flocculent polymer.

Obtaining such a level of quality implies however that natural polymer will be used in quantities far greater than that of classic organic polymer. However, natural polymers are currently less costly than classic organic polymers. Furthermore, the cost of the latter, which are petroleum derivatives, is not likely to stop increasing in years to come. Thus, the use of natural polymers as a substitute for classic organic polymers, undoubtedly in greater proportions, should not have any negative impact on the cost of production of treated water by ballasted coagulation-flocculation.

In addition, the results of the test described here above also show that the implementation, in the treatment of water by ballasted coagulation-flocculation, of natural flocculent polymers (in this case substituted starch) in proportions ten times greater than that of synthetic organic flocculent polymer produces treated water with levels of quality that are fairly similar in terms of DOC content, turbidity and UV absorbance at 254 nm.

Surprisingly, the use of such large doses of natural flocculent polymer does not entail any major increase in the biological DOC of the treated water as those skilled in the art would normally expect.

For example, referring to the above table 1, the treated water using a dose of 2 ppm of C*PLUS 35704 does not have a biological DOC content that is significantly greater than that of water treated with a dose of 0.2 ppm of FLOPAM AN905. However, adding organic flocculation additive to water in a quantity that is ten times greater obviously prompted fears on the part of those skilled in the art of a risk of major increases in the biological DOC of the treated water. Those skilled in the art therefore in practice had no reason to add organic flocculent to water to be treated using doses significantly greater than those used with the additives formed by synthetic organic polymers.

Finally, the invention also makes use of natural polymers that are biodegradable. Their use therefore has no harmful effect on the environment or on the health of individuals.

Two other tests have been reproduced under the same conditions as those of the two tests described here above, but with raw water that is less charged in organic matter and has an alkalinity of 5°f (i.e. 50 mg/l of CaCO₃) with doses of coagulant and flocculent that are different, as indicated in table 2 here below.

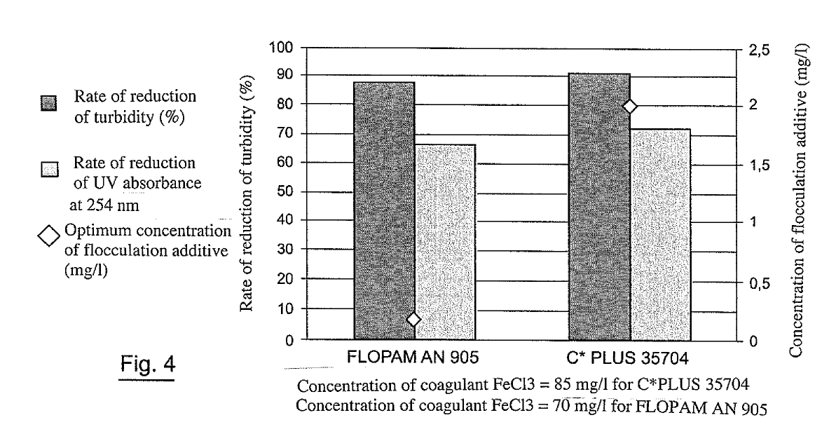

The results of these tests on the rate of reduction of the turbidity of raw water and of the rates of reduction of UV absorbance at 254 nm are indicated in FIG. 4.

TABLE 2

| | | | | | Coagulant |
|---|---|---|---|---|---|
| | Bio- | | | polymer | dose |
| | degradable | DOC* | polymer | dose | (FeCl₃) |
| Sampling point | DOC (mg/l) | (mg/l) | used | (ppm) | (ppm) |
| Raw water | 1.5 | 4.5 | C*PLUS | 2 | 85 |
| Water outflow | 0.4 | 1.5 | 35704 | | |
| after | | | | | |
| ballasted | | | | | |
| coagulation- | | | | | |
| flocculation | | | | | |
| and settling | | | | | |
| Raw water | 1.3 | 4.7 | FLOPAM | 0.2 | 70 |
| Water outflow | 0.3 | 1.3 | AN905 | | |
| after | | | | | |
| ballasted | | | | | |
| coagulation- | | | | | |
| flocculation | | | | | |
| and settling | | | | | |

DCO*: the precision of the measurement is 0.3 mg/l

7.4.2. Trials in the Context of the Implementation of a Method According to the Second Embodiment

Water was treated by the application of a method according to the second embodiment, entailing a variation in the dose of iron chloride (FeCl₃), a commercially available product, injected into the water flowing out of the settling tank, and by measuring the loss of permeability recorded in the ultrafiltration unit.

The loss of permeability was equal to 20.7 L/(h·bar·m²) for a dose of 0.05 ppm of FeCl₃. It was equal to 4.5 L/(h·bar·m²) for a dose of 0.1 ppm of FeCl₃. It was equal to 2.8 L/(h·bar·m²) for a dose of 0.15 ppm of FeCl₃.

The results of these trials show that the fact of coagulating water at exit from the settling tank reduces its clogging potential and consequently limits the clogging of the ultrafiltration unit placed downstream.

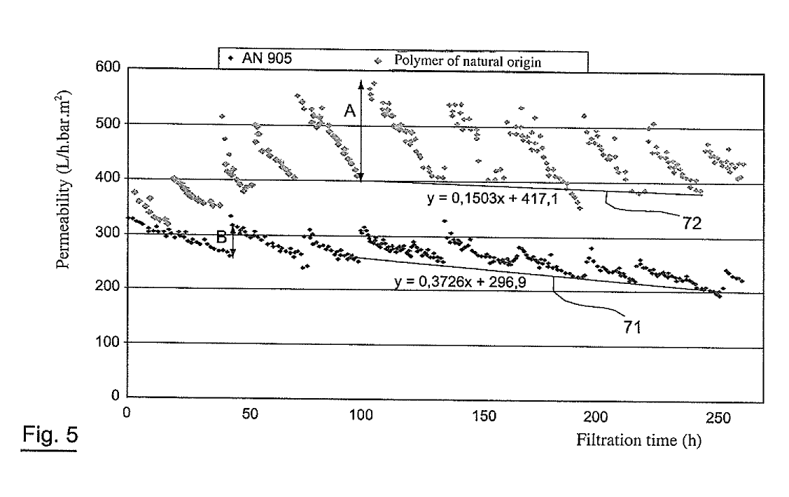

FIG. 5 is a graph illustrating the variation in permeability in the ultrafiltration unit during the implementation of the method according to the second embodiment firstly with the use of anionic synthetic polymer with a charge density equal to −1400 μeq/g and secondly through the use of the natural polymer C* plus 35704 (substituted starch for which the anionic load density is equal to −900 μeq/g). During these trials, phases of washing the ultrafiltration unit were implemented.

With the polymer of synthetic origin FLOPAM AN905, the sequences of the filtration and washing of the ultrafiltration unit were distributed as follows:
filtering for 40 minutes with preliminary injection of 0.15 ppm of ferric chloride, a commercially available product, in water coming from the settling tank;
every 40 minutes: backwashing for 40 seconds;
every 24 hours: maintenance cleaning including an injection of sodium hydroxide for 25 seconds, dipping (keeping the sodium hydroxide in the ultrafiltration unit) for 10 minutes, rinsing for 80 seconds, filtering for 40 minutes, injection of acid for 25 seconds, dipping for 10 minutes, rinsing for 80 seconds.

With the substituted starch C* plus 35704, the sequences of filtering and washing the ultrafiltration unit were distributed as follows:
filtering for 40 minutes with preliminary injection of 0.15 ppm of ferric chloride, a commercially available product, in water coming from the decanter;
every 40 minutes: backwashing for 40 seconds;
every 24 hours: maintenance cleaning including an injection of sodium hydroxide for 25 seconds, dipping (keeping the sodium hydroxide in the ultrafiltration unit) for 10 minutes, rinsing for 80 seconds, filtering for 40 minutes, injection of acid for 25 seconds, dipping for 10 minutes, rinsing for 80 seconds.

The graph of FIG. 5 shows that starch-based polymer which collects on the surface of the membranes of the ultrafiltration unit is eliminated more easily than the synthetic polymer because:
the washing operations implemented during the use of the natural flocculent polymer are less powerful and less frequent than those implemented during the use of synthetic polymer, and because
the difference in permeability of the ultrafiltration module between the end of the filtration cycle and the start of the next cycle following a maintenance cleaning operation is greater during the use of the natural flocculent polymer (arrow A) than during that of the synthetic polymer (arrow B).

In addition to the maintenance cleaning operations, clean-in-place operations must be performed as soon as the permeability reaches a predetermined lower threshold for which the value was fixed at 180 L/(h·bar·m²) during the trials. The plotting of linear regression straight lines on the graph illustrated in FIG. 5 on the basis of the permeability achieved at the end of each filtration cycle (straight lines 71 and 72) makes it possible to assess the frequency at which the clean-in-place operations have to be performed. For an ultrafiltration module working 24 hours out of 24 with water outlet permeability of 550 L/(h·bar·m²), the clean-in-place operations were implemented every month in the context of the use of anionic synthetic polymer with a charge density equal to −1400 μeq/g (straight line 71) and every four months in the context of the use of polymer based on substituted starch (straight line 72).

Starch-based polymer is therefore less viscous and has less clogging potential than organic polymer. Its implementation reduces the frequency of washing of the ultrafiltration unit. This can be explained especially by the fact that it is biodegradable.

### 7.5. Main Advantages

Flocculants formed by natural carbohydrate polymers functionalized by anionic functional groups such as substituted starches have an anionic charge density ranging from −900 to −4000 μeq/g present especially the following advantages:
they enable the production of treated water with a quality comparable to that of water produced by using synthetic organic flocculants;
they are biodegradable and have no impact on the environment or on individuals;
they have a limited clogging potential;
they can be easily removed from the filtration membranes during unclogging operations;
they are inexpensive;
they are not derived from petroleum like the synthetic organic flocculants;
their costs are therefore not indexed to petroleum prices which are only likely to increase in years to come.

1-14. (canceled)

15. A method for treating water by ballasted flocculation comprising:
injecting into said water at least one flocculent,
injecting into said water at least one particulate material that is denser than water, and
retrieving treated water,
characterised in that said ballasted flocculation is performed under agitating at a mean speed gradient between 100 and 1400 s⁻¹ and in that said flocculent comprises at least one natural carbohydrate polymer having an anionic charge density between −900 and −4000 μeq/g.

16. The method according to claim 15, characterised in that said flocculent is a substituted starch.

17. The method according to claim 16, characterised in that said substituted starch has a substitution rate between 0.1 and 0.5.

18. The method according to claim 15, characterised in that at least one substituent of said starch is selected from the group comprising carboxylate, sulphonate, phosphate, and phosphonate substituents.

19. The method according to claim 15, further comprising injecting a first coagulant into the water prior to injecting into said water the flocculent.

20. The method according to claim 15, further comprising directing the water to a settling tank after injecting into said water the particulate material that is denser than water.

21. The method according to claim 19, further comprising injecting activated carbon into said water prior to injecting the coagulant into the water.

22. The method according to claim 20, further comprising directing the water to a filter and filtering the water after directing the water to the settling tank.

23. The method according to claim 22, further comprising injecting a second coagulant into the water immediately before filtering the water.

24. The method according to claim 15, further comprising selecting the flocculent according to the hardness of the water to be treated.

25. The method according to claim 19, characterised in that injecting into the water at least one flocculent is performed by adding the flocculent to the previously coagulated water in an amount between 0.1 and 5 ppm.

26. The method according to claim 15, characterised in that said ballasted flocculation is performed under agitating with a mean speed gradient between 200 and 800 s⁻¹.

27. The method of claim 25, wherein the flocculent is added to the previously coagulated water in an amount between 0.1 and 2 ppm.

28. The method of claim 24, wherein selecting the flocculent according to the hardness of the water to be treated is performed such that an increase in the hardness of the water signifies the selection of a more anionic flocculent.
